(19) United States
(12) Patent Application Publication
(10) Pub. No.: US 2009/0141179 A1
(43) Pub. Date: Jun. 4, 2009

(54) Cellular Antenna Assembly With Video Capability

(76) Inventors: Hyun JUNG, Fishers, IN (US); Yeung KIM, Placentia, CA (US)

Correspondence Address: STORM LLP, BANK OF AMERICA PLAZA, 901 MAIN STREET, SUITE 7100, DALLAS, TX, 75202, US

(21) Appl. No.: 12/277,188

(22) Filed: Nov. 24, 2008

Related U.S. Application Data
(60) Provisional application No. 60/990,553, filed on Nov. 27, 2007.
(60) Provisional application No. 61/023,941, filed on Jan. 28, 2008.
(60) Provisional application No. 61/041,074, filed on Mar. 31, 2008.

(51) Int. Cl. H04N 5/38

(52) U.S. Cl. 348/723; 348/E05.093

(57) ABSTRACT

An antenna assembly is disclosed for analyzing conditions of an antenna and its surroundings with video technology including an antenna housing wherein an antenna panel is disposed, and a camera that is in connection with the antenna panel and is coupled to a computer system for storing and transmitting data through a packet switching network to a user who may communicate using a user interface. In an exemplary embodiment, an antenna assembly may further comprise an adjustment system that is capable of controlling azimuth and downtilt movement and as well as the focus of the camera under direction of a control unit in a remote location.

### CLAIM OF PRIORITY

This Application claims the benefit of the following U.S. Provisional Patent Applications: No. 60/990,553 entitled “Central Antenna Management System” filed on behalf of Hyun Jung on Nov. 27, 2007; No. 61/023,941 entitled “Central Antenna Management System” filed on behalf of Hyun Jung and Yeung Kim on Jan. 28, 2008; and No. 61/041,074 entitled “Cellular Antenna Assembly With Video Capability” filed on behalf of Hyun Jung on Mar. 31, 2008.

### BACKGROUND

1. Technical Field

The present technology relates generally to antenna assemblies for use in the transmission and reception of radio-frequency signals in a cellular telephone network. More particularly, the present technology relates to such an assembly having the capability to analyze conditions of the antenna and its surroundings using video technology.

2. Description of the Related Art

With the popularity of cellular wireless communications, advances have been made in the antenna systems used to transmit and receive radio-frequency signals between cells in a cellular network. Recently, the ability to remotely control the azimuth, downtilt, and beamwidth of the antenna to fine-tune its coverage within the cellular network has been the focus of much of the cellular antenna industry. Azimuth, downtilt, and beamwidth of an antenna typically are controlled both mechanically, by physically adjusting the antenna panel, and electromagnetically, by adjusting electrical characteristics such as the phase shift of the signal propagated by the antenna. Accordingly, the coverage of an antenna signal can be adjusted quite precisely to fit current needs.

A variety of environmental factors, such as strong winds, can cause the azimuth or downtilt of the antenna to change such that the antenna no longer provides the desired coverage. In many cases the undesirable change can be detected and corrected remotely. In some cases, for example, wind damage to the antenna assembly can only be detected and corrected with the physical presence of a technician at the antenna site to observe the problem and correct it.

### SUMMARY

An exemplary embodiment provides an improved antenna assembly, including an antenna housing and an electro-magnetic antenna panel coupled to and disposed within the housing. The antenna panel may be controlled electro-magnetically and/or mechanically for conditions including downtilt, azimuth and beamwidth. A video system is associated with the antenna panel for visually detecting and transmitting video data for control of antenna conditions other than electro-magnetic antenna conditions.

According to another exemplary embodiment of the present technology, the camera communicates with a computer or data-processing system that stores and serves live or historical video images for display at a user interface. The computer system may be remote from the antenna assembly.

According to a further exemplary embodiment, the camera communicates with the computer or data-processing system through a wireless packet switching network.

### BRIEF DESCRIPTION OF THE DRAWINGS

FIG. 1 is an elevation view of an antenna assembly according to an exemplary embodiment.

FIG. 2 is a view of a lower portion of the antenna assembly of FIG. 1.

FIG. 3 is a view of the camera module of the antenna assembly of FIG. 1.

FIG. 4 is a view of the camera module housing and the protective cover of the antenna assembly of FIG. 1.

FIG. 5 is a perspective view of an upper portion of the antenna assembly of FIG. 1.

FIG. 6 is a view of the camera module of the antenna assembly of FIG. 1.

FIG. 7 is a block diagram depicting components of the control and computer system for use in combination with the antenna assembly of FIG. 1.

FIG. 8 is a view of an exemplary embodiment of an antenna assembly system that includes a plurality of the antenna assemblies of FIG. 1.

FIG. 9 is a simplified diagram depicting an example of an aggregation of multiple antenna assembly systems of FIG. 8.

### DETAILED DESCRIPTION OF THE INVENTION

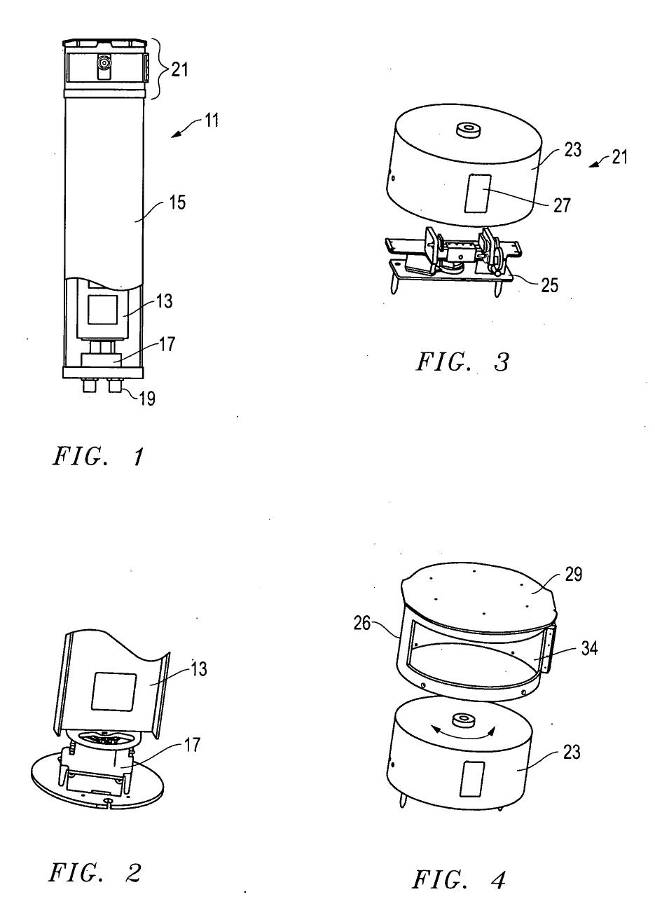

FIGS. 1 and 2 illustrate an exemplary embodiment of an antenna assembly 11. The assembly includes an antenna panel 13 that is mounted inside a generally cylindrical or tubular housing 15, which may be formed of electro-magnetically transmissive material. Housing 15 is generally stationary and typically is mounted on an antenna tower or the roof of a building in groups with other antenna assemblies with common control.

Electrical power to the antenna system, including steering module 17, as well as radio frequency and control signals, may be provided through electrical connections 19 to feeder lines. A video camera module generally designated at 21 is provided at the top of antenna housing 15 and receives power and control signals from feeder lines through electrical connections 19. The video camera module 21 may be detachable from the top of antenna housing 15 if it is not needed or requires repair or maintenance.

FIGS. 3, 4 and 5 are views of portions of camera module 21. As shown in FIG. 3, a camera shroud 23 surrounds and encloses a video camera assembly 25 (depicted in greater detail in FIG. 5). Camera shroud 23 may be generally cylindrical and includes a camera window or aperture 27 through which light is received by the lens of camera assembly 25 and video images are captured. Camera shroud 23 and camera assembly 25 are secured together by fasteners, such as cap screws or bolts. Thus, camera shroud 23 and camera assembly 25 move together.

Camera assembly 25 and camera shroud 23 rotate together, in tandem with the antenna panel 13, within a camera housing 26 (FIG. 4). Camera housing 26 is secured to the antenna housing 15 and does not move with antenna panel 13. A relatively large camera window 34, traversing approximately 180 degrees of the circumference of camera housing 26, is provided to permit the video camera to pan or be rotated through an arc of approximately that dimension while capturing video images. Protective cover 29 may be secured to camera housing 26 in inclement weather conditions.

FIG. 5 illustrates how camera housing 26, shroud 23 and camera assembly 25 are coupled to antenna housing 15 and antenna panel 13. As shown, camera housing 26 is secured to antenna housing 15 by conventional fasteners, such as bolts or cap screws. Camera assembly 25 and camera shroud 23 are coupled or secured to antenna panel 13 by guide pins 31, which are received in guide receptacles 33 that are coupled to the antenna panel 13 itself. Bearing 36 extends pivotally downward from the top of camera shroud 23, through camera module 25 and into antenna panel 13 providing pivotal support to steering module 17. Thus, movement of camera assembly 25 and camera shroud 23 is controlled by and moves with antenna panel 13. An electrical connection 35, such as a coaxial cable, may be provided between camera assembly 25 and the interior of housing 15 to provide electrical power and to communicate control signals and video signals to and from camera assembly 25.

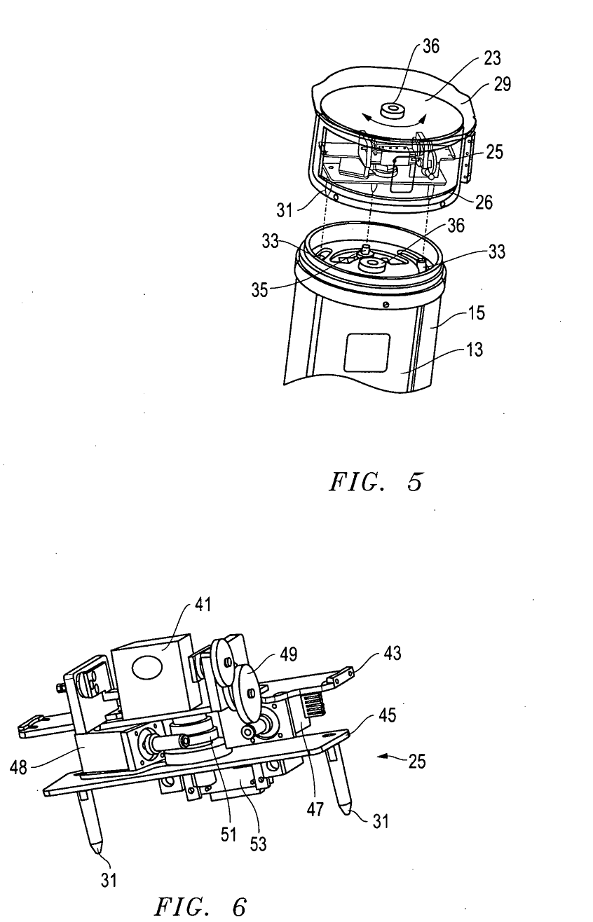

FIG. 6 depicts camera assembly 25 in greater detail. Camera assembly 25 includes a CCD or CMOS video camera 41. Camera 41 is pivotally mounted for both pan (left and right) and tilt (up and down) motion to upper and lower brackets 43, 45, by drive mechanisms. Guide pins 31 extend from lower bracket 45. Drive mechanisms include a tilt motor 47, which is coupled by a tilt gear train 49 to camera 41. Tilt motor 47 is an electronically controlled servo or stepper motor that turns gears in train 49 to achieve up and down or tilt motion of camera 41 relative to camera assembly 25 and camera shroud 23 to which it is coupled. A pan motor 48 and pan gear train 51 operate similarly to effect left and right or rotational motion of camera 41 relative to camera assembly 25 and shroud 23. Camera assembly 25 also includes a control module 53 mounted to the lower bracket 45 to control camera 41 and its native focus and zoom functions. Motors 47, 48 can provide position data themselves, or separate sensors may be employed to detect the degree of pan and tilt of camera 41. Pan of camera 41 is analogous to azimuth of antenna 13, while tilt of camera 41 is analogous to downtilt of antenna 13. Control of tilt and pan can be effected by the control of motors 47, 48.

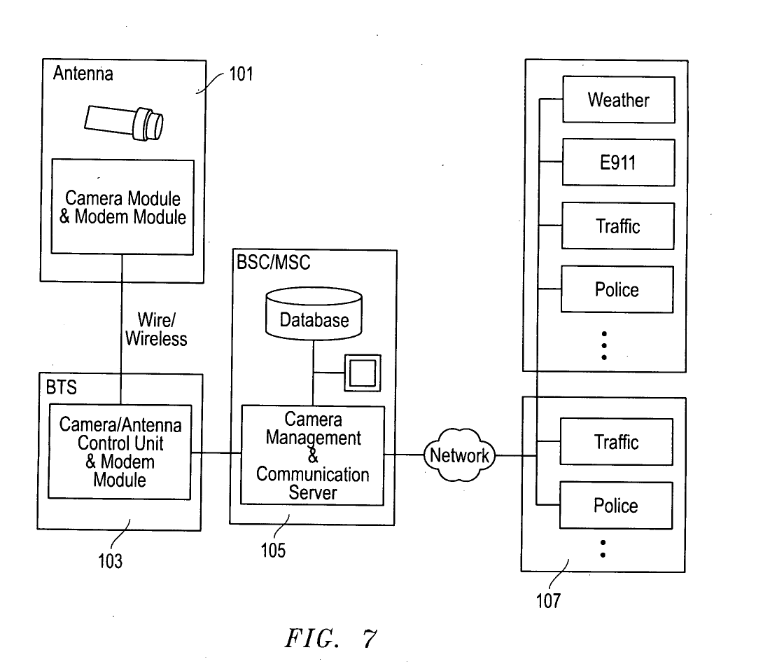

FIG. 7 is a block diagram depicting the control and communication system employed in conjunction with the improved antenna assembly described herein. Block 101 represents the video camera and its control and communication system, which communicates image data and its position and orientation to a camera control unit that is also associated with an antenna control unit, depicted at block 103. A camera 41 may communicate through any sort of conventional wired or wireless link or a wireless packet-switched network. The video from camera 41 may be streamed “live” to a user over a computer network such as the Internet, or to a video-on-demand (VOD) server, using International Telecommunication Union standard H.264 encoding. Audio from the camera 41 may be streamed live to a user or to a VOD server, using International Organization for Standardization (ISO) standard Advanced Audio Coding (AAC) encoding. The antenna and camera control unit communicates antenna (azimuth, downtilt, beamwidth) and camera (pan, tilt) condition and positioning data, and image data to a control center depicted at block 105. At control center 105, antenna and camera image data may be stored, reviewed, and analyzed to determine whether antenna assembly 11 is performing as intended. Image pattern-recognition software may be employed to analyze images from camera 41 to detect changes in the image (and changes to antenna positioning) without human intervention.

Moreover, both antenna 13 and camera module 21 may be remotely controlled to adjust their various characteristics. In particular, video data can be analyzed remotely to determine if an antenna characteristic or malfunction is due to physical causes that are evident from video image data and less so from more conventional data regarding antenna position and function. Specifically, for example, if storm damage has misaligned the antenna assembly, causing inaccurate azimuth positioning that is not a result of intended antenna positioning (by steering assembly 17) or the like.

Video image data from camera module 21 may be available for purposes unrelated to antenna function or operation. Video and audio from a VOD server may be served subsequently to a wide variety of devices including personal computers and mobile telephones through a computer network, including but not limited to a packet-switched network (“the Internet”); for example, for weather, crime, or fire detection purposes. Live or historical (recorded) video may be transmitted via packet-switching network (“the Internet”) to governmental or news agencies as appropriate and desirable, as depicted at block 107.

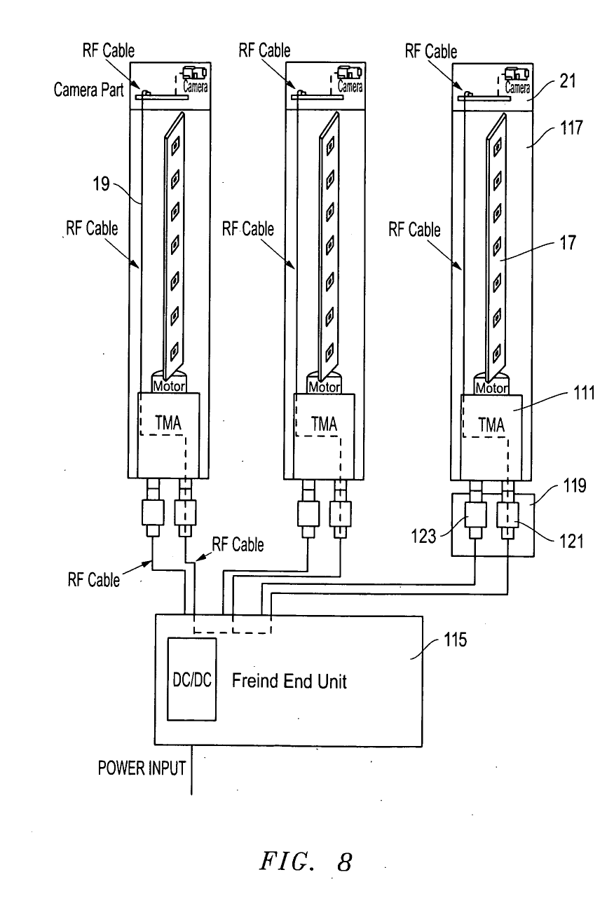

FIG. 8 illustrates another exemplary embodiment of an antenna assembly system. The system includes a plurality of antenna assemblies 11, Bias-T 113 and a Front End Unit 115. Each of the antenna assemblies 11 includes a camera module 21 and an antenna 117 that further includes a TMA 111 (tower mounted amplifier) and an antenna panel 17. Camera module 21 may also utilize a plurality of modems (not shown), such as WiBro/Wi Max modems with USB interface and/or PLC modems with Ethernet interface, to communicate with the network. Within the antenna assembly 11, TMA 111 functions as an intermediary that relays power and data to camera module 21 from Bias-T (not shown), which is coupled to the lower part of each of the antenna assemblies 11 and interfaces with feeder lines from Front End Unit 115 for control signal and power deliveries. A Front End Unit 115 is provided to control and power the plurality of antenna assemblies 11 by providing each of the antenna assemblies 11 with a corresponding sector 119. Each corresponding sector 119 includes two ports 121, 123 configured such that while one of the ports 123 controls and powers the antenna of the antenna assembly, the other 121 controls and powers the camera module. Power may be delivered by each part of the antenna assembly 11 using Bias-T that combine RF power and DC signals, and control signals may be delivered using Frequency-Shift keying or On-Off keying modulation schemes.

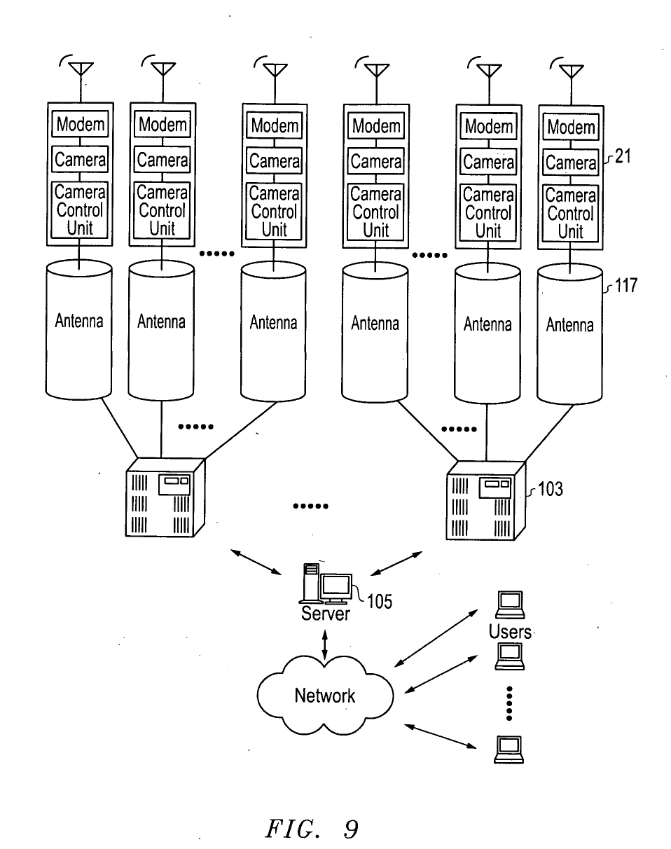

FIG. 9 shows an exemplary usage of multiple antenna assembly systems with the network. As shown, a plurality of antenna assembly systems may communicate through a plurality of Base Transceiver Stations 103 with a server 105 that further communicates with users or administrators through a computer network. Also as shown in the figure, each camera module 21 may also utilize a plurality of modems, such as WiBro/Wi Max modems with USB interface and/or PLC modems with Ethernet interface, to communicate with the network.

Having thus described the present technology by reference to certain of its exemplary embodiments, it is noted that the embodiments disclosed are illustrative rather than limiting in nature and that a wide range of variations, modifications, changes, and substitutions are contemplated in the foregoing disclosure and, in some instances, some features of the present technology may be employed without a corresponding use of the other features. Many such variations and modifications may be considered obvious and desirable by those skilled in the art based upon a review of the foregoing description of exemplary embodiments. Accordingly, it is appropriate that the appended claims be construed broadly and in a manner consistent with the scope of the invention.

We claim:

1. An improved antenna assembly, comprising:
an antenna housing;
an electro-magnetic antenna panel disposed within the housing, orientation of the antenna panel controlled for conditions comprising downtilt, azimuth, and beamwidth; and
a video system associated with the antenna panel for visually detecting and transmitting video data to control the antenna conditions other than electro-magnetic antenna conditions.

2. The antenna assembly of claim 1, wherein the housing comprises an electro-magnetic transmissive material.

3. The antenna assembly of claim 1, wherein the video system comprises a digital camera recording images and transmitting bit streams corresponding to the images to a remote location.

4. An improved antenna system for a cellular communications network, comprising:
an antenna housing;
an antenna panel disposed within the housing;
a camera disposed inside the housing and moving in concert with the antenna panel; and
a computer system in communication with the camera for storing and transmitting live or historical images and video captured from the camera, the computer system comprising:
a packet switching network coupling the computer system to the camera; and
a user interface, the user interface communicating with the packet switching network to display captured images or video, the user interface enabling a user to determine whether a change in antenna orientation has occurred.

5. The antenna system of claim 4, further comprising:
an adjustment system, the adjustment system disposed in the housing, the adjustment system communicating with the camera, the adjustment system communicating with the packet switching network, the adjustment system including:
an azimuth drive system communicating with the camera to control camera azimuth;
a downtilt drive system communicating with the camera to control camera downtilt; and
a camera focus system communicating with the camera to control camera focus; and
a control system, located remote from the antenna, communicating with the packet switching network to control the adjustment system.

6. The antenna system of claim 4, wherein the system comprises multiple antenna housings, each having an antenna panel and a camera in communication with the computer system.

7. The antenna system of claim 4, wherein the user interface permits user input for transmission to control and modify a detected orientation of the antenna panel.

8. The antenna system of claim 4, wherein the antenna panel is able to reorient to accommodate conditions including azimuth, beamwidth and downtilt.

9. The antenna system of claim 4, wherein the camera is a digital video camera and the system further comprises a camera mountable to orient the camera under control of a camera control unit.

10. The antenna system of claim 4, wherein the camera communicates with the computer system via a computer network.

11. The antenna system of claim 9, wherein the camera control unit receives control signals from the computer, either automatically based on transmitted video image analysis or by user input.

12. The antenna system of claim 11, wherein the communication is wireless.

13. An improved antenna assembly comprising:
an antenna housing;
an antenna panel movably mounted within the housing, such that the antenna panel is azimuth adjustable;
a camera module secured within the housing, the camera module housing a video camera movable in tandem with the antenna panel; and
a camera control module, coupled to the video camera, for adjusting tilt and pan of the video camera independent of movement of the antenna panel.
